(19) United States
(12) Patent Application Publication
(10) Pub. No.: US 2017/0248098 A1
(43) Pub. Date: Aug. 31, 2017

(54) METHOD FOR MANUFACTURING CYLINDER BLOCK AND CYLINDER BLOCK

(71) Applicant: TOYOTA JIDOSHA KABUSHIKI KAISHA, Aichi-ken (JP)

(72) Inventors: Yu YAMAMOTO, Toyota-shi (JP); Keisuke UCHIDA, Nagoya-shi (JP)

(21) Appl. No.: 15/436,555

(22) Filed: Feb. 17, 2017

(30) Foreign Application Priority Data
Feb. 26, 2016 (JP) 2016-036135

(51) Int. Cl. F02F 1/14; B23K 20/12; F01P 3/02

(52) U.S. Cl. CPC F02F 1/14; F01P 3/02; B23K 20/1265; F02F 2200/00; F01P 2003/021

(57) ABSTRACT

A bridge member is installed in an opening of a water jacket, and a probe of a friction stir welding tool, which rotates about an axis parallel to a cylinder axis, is pressed against a central part of an upper surface of the bridge member. The probe is kept pressed against the central part of the upper surface for a predetermined time to cause side surfaces of the bridge member to expand and come into contact with both a cylinder wall and an outer wall. The probe is moved from the central part of the upper surface to the outer wall, or the cylinder wall, while the probe is kept pressed against the upper surface, thereby friction-stir welding the outer wall, or the cylinder wall, with the bridge member to each other, and after that, the probe is removed off the top deck.

### CROSS-REFERENCE TO RELATED APPLICATION

This application claims priority from Japanese Patent Application No. 2016-036135 filed with the Japan Patent Office on Feb. 26, 2016, the entire contents of which are incorporated into the present specification by reference.

### BACKGROUND

Technical Field

The present application relates to a method for manufacturing a cylinder block. In particular, it relates to a method for manufacturing a semi-closed deck cylinder block.

Background Art

A typical cylinder block of an engine includes a cylinder wall into which a piston is inserted and an outer wall that surrounds the cylinder wall with a water jacket interposed therebetween, and cylinder blocks are classified into three types according to the opening of the water jacket in the top deck. Specifically, cylinder blocks are classified into an open deck type in which the water jacket has an opening in the top deck, a closed deck type in which the water jacket is closed at the top deck, and a semi-closed deck type in which the water jacket is partially closed at the top deck.

JP H11-236850A describes a method for manufacturing a closed deck cylinder block by machining an open deck cylinder block material. According to this method, a lid member having substantially the same shape as the opening in the top deck of the water jacket formed in the cylinder block material is inserted into the opening of the water jacket, and high pressure is applied to the upper surface of the lid member to cause plastic deformation of the lid member. The lid member is plastically deformed to fill the gap between the cylinder wall and the lid member and the gaps between the outer wall and the lid member. In this way, a closed deck cylinder block with the opening closed by the lid member is provided.

JP H03-253753A describes a method for manufacturing a semi-closed deck cylinder block by machining an open deck cylinder block material. According to this method, a deck reinforcing piece is inserted at a predetermined position into an opening in the top deck of the water jacket formed in the cylinder block material manufactured by aluminum die casting, the deck reinforcing piece is positioned such that one end of the deck reinforcing piece that is closer to the cylinder wall comes into contact with the cylinder wall, and a high energy beam is applied to the gap between one end of the deck reinforcing piece that is closer to the outer wall and the outer wall and its peripheral region to make the deck reinforcing piece and the outer wall at the gap and its peripheral region molten. Since the deck reinforcing piece and the outer wall become molten, the materials of the deck reinforcing piece and the outer wall are mixed to fill the gap therebetween. In this way, a semi-closed deck cylinder block with the opening of the water jacket partially closed by the deck reinforcing piece is provided.

### SUMMARY

A method for manufacturing a cylinder block according to one or more embodiments of the present application is a method for manufacturing a semi-closed deck cylinder block. The semi-closed deck cylinder block includes a cylinder wall of a cylinder into which a piston is to be inserted, an outer wall that surrounds the cylinder wall with a water jacket interposed therebetween, and a bridge that connects the cylinder wall and the outer wall to each other and blocks a part of an opening of the water jacket at a top deck of the cylinder block. The method comprises a pressing step, a keeping step, a welding step, and a removing step. The pressing step is a step of pressing a probe of a friction stir welding tool against a central part of an upper surface of a bridge member installed in the opening of the water jacket at the top deck, the probe rotating about an axis parallel to a cylinder axis of the cylinder. The keeping step is a step of keeping the probe pressed against the central part for a predetermined time to cause side surfaces of the bridge member to expand as a result of the probe being pressed against the upper surface thereof and to come into contact with both the cylinder wall and the outer wall. The welding step is a step of, after the predetermined time, moving the probe to the cylinder wall or the outer wall while keeping the probe pressed against the upper surface to friction-stir weld the bridge member with the cylinder wall or the outer wall to which the probe has moved. The removing step is a step of removing the probe from the top deck after the welding step.

A cylinder block according to one or more embodiments of the present application comprises a cylinder wall of a cylinder into which a piston is to be inserted, an outer wall that surrounds the cylinder wall, a water jacket interposed between the cylinder wall and the outer wall, and a bridge. The bridge connects the cylinder wall and the outer wall to each other, and blocks a part of an opening of the water jacket at a top deck of the cylinder block. Side surfaces of the bridge at a top part of the bridge extend in a radial direction of the cylinder outwardly beyond the side surfaces at a bottom part of the bridge. One of the side surfaces of the bridge at the top part of the bridge is connected to one of the cylinder wall and the outer wall at a welded portion.

### BRIEF DESCRIPTION OF DRAWINGS

FIG. 1 is a diagram for illustrating a flow of a method for manufacturing a cylinder block according to one or more embodiments of the present application;

FIG. 2 is a diagram for illustrating a configuration of a cylinder block material shown in Step 1 in FIG. 1;

FIG. 3 is a diagram for illustrating an example of installation of a bridge member shown in Step 1 in FIG. 1;

FIG. 4 is a diagram for illustrating a potential result of a friction stir welding tool during use;

FIG. 5 is a diagram for illustrating a flow of a method for manufacturing a cylinder block according to a comparative example; and

FIG. 6 is a diagram for illustrating a flow of a method for manufacturing a cylinder block according to one or more embodiments of the present application.

### DESCRIPTION OF EMBODIMENTS

In the following, one or more embodiments of the present application will be described with reference to the drawings. In the drawings, the same elements are denoted by the same reference numerals, and redundant descriptions thereof will be omitted.

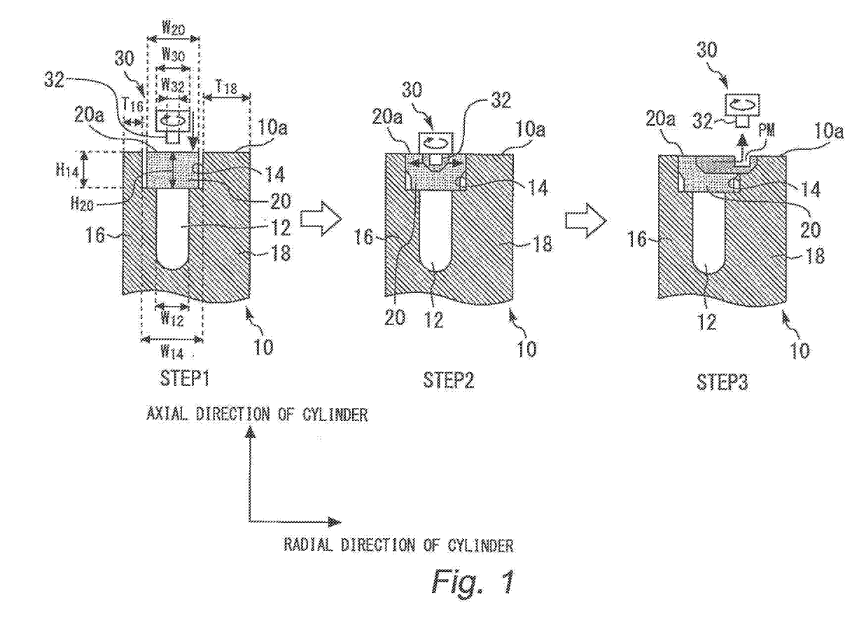

First, with reference to FIGS. 1 to 4, a method for manufacturing a semi-closed deck cylinder block of an engine according to one or more embodiments of the present application will be described. FIG. 1 is a diagram for illustrating a flow of the manufacturing method according to one or more embodiments of the present application. As shown in FIG. 1, the manufacturing method according to one or more embodiments begins with installing a bridge member 20 (for example, a cylindrical bridge member) in an opening 14 of a water jacket 12 formed in a cylinder block material 10, and pressing a probe 32 of a friction stir welding tool (hereinafter referred to as “FSW tool”) 30, which rotates about an axis parallel to a cylinder axis of a cylinder in the cylinder block to be manufactured, against a central part of an upper surface 20a of the bridge member 20 (Step 1).

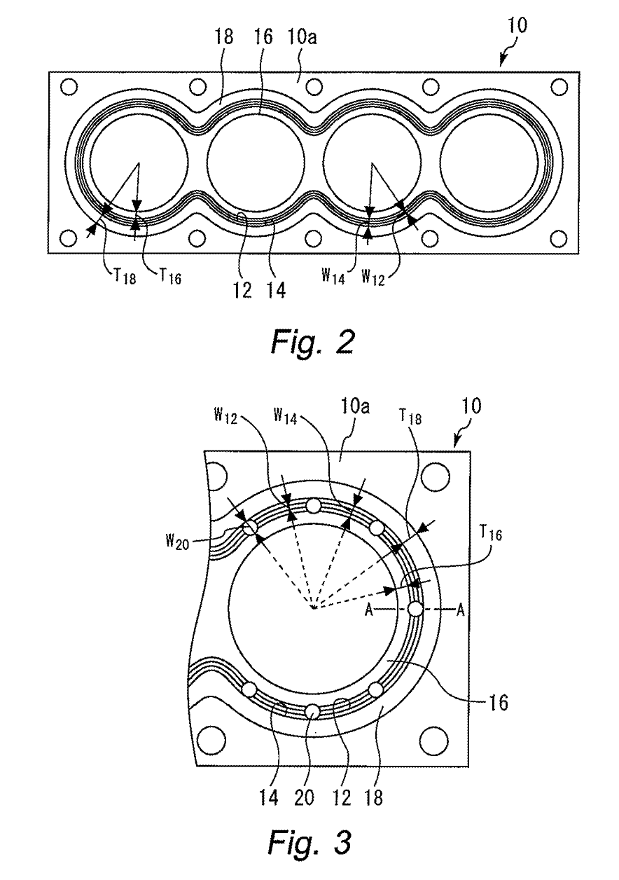

FIG. 2 is a diagram for illustrating a configuration of the cylinder block material shown in Step 1 in FIG. 1. The cylinder block material 10 shown in FIG. 2 is a cylinder block material for an inline four cylinder engine and is manufactured by aluminum die casting, which is one of metal mold casting processes (note that, however, the number and arrangement of the cylinders are not limited to those described herein). Castings manufactured by aluminum die casting have not only high dimensional accuracy but also high strength depending on the choice of the material. Thus, the cylinder block manufactured by aluminum die casting can be adopted for an engine that has increased power and therefore has increased in-cylinder pressure, and at the same time, the thickness of the wall of the cylinder block can be reduced as far as the cylinder block has required strength and rigidity, thereby contributing to the reduction of the weight of the engine.

The cylinder block material 10 shown in FIG. 2 includes a cylinder wall 16 of a cylinder into which a piston (not shown) is to be inserted, and an outer wall 18 that surrounds the cylinder wall 16 with the water jacket 12 interposed therebetween. The opening 14 of the water jacket 12 is formed in a top deck 10a of the cylinder block material 10, and a width W₁₄ of the opening 14 in the radial direction of the cylinder is greater than a width W₁₂ of the water jacket 12 in the radial direction of the cylinder. As shown in FIG. 2, a thickness T₁₆ of the cylinder wall 16 at the opening 14 in the radial direction of the cylinder is smaller than a thickness T₁₈ of the outer wall 18 in the radial direction of the cylinder.

A width W₂₀, in the radial direction of the cylinder, of the bridge member 20 installed in the opening 14 in Step 1 in FIG. 1 is greater than the width W₁₂ and smaller than the width W₁₄. Thus, although the bridge member 20 does not fall into the water jacket 12 from the opening 14 in Step 1, there is a gap in the radial direction of the cylinder between the cylinder wall 16 or the outer wall 18 and the side surface of the bridge member 20. Although a height H₂₀ of the bridge member 20 in the axial direction of the cylinder is shown in FIG. 1 as being substantially equal to a height H₁₄ of the opening 14 in the axial direction of the cylinder, the height H₂₀ is not particularly limited and, in some example configurations, is smaller or greater than the height H₁₄.

FIG. 3 is a diagram for illustrating an example of the installation of the bridge member in Step 1 shown in FIG. 1. FIG. 3 shows a longitudinal end of the cylinder block material 10 shown in FIG. 2. As shown in this drawing, a total of seven bridge members 20 are installed at generally regular intervals along the opening 14 (or the water jacket 12) (note that, however, the number and sites of installation of the bridge members 20 are not limited to those described herein). The cross section of the cylinder block material 10 across the water jacket 12 taken along the line A-A in the radial direction of the cylinder shown in FIG. 3 is shown in FIG. 1.

A width W₃₂ of the probe 32 in the radial direction of the cylinder shown in Step 1 in FIG. 1 is smaller than the width W₂₀ and smaller than the width W₁₂. Thus, when the probe 32 is pressed against the central part of the upper surface 20a in Step 1, the probe 32 gradually penetrates into the central part. In Step 1, the material of the cylinder wall 16 or the outer wall 18 and the material of the bridge member 20 are not mixed with each other. Although a width W₃₀ of the FSW tool 30 in the radial direction of the cylinder is shown in FIG. 1 as being substantially equal to the width W₁₂, the width W₃₀ is not particularly limited and, in some example configurations, is smaller or greater than the width W₁₂. The width W₃₀, in some example configurations, is greater than the width W₂₀.

In the manufacturing method according to one or more embodiments, after Step 1, the probe 32 is kept pressed against the upper surface 20a in the central part thereof for a predetermined time (Step 2).

Since the probe 32 is rotating, when the probe 32 is kept pressed against the upper surface 20a in the central part thereof in Step 2, heat (frictional heat) produced by friction between the two causes softening of the central part and thus outward expansion of a top part of the bridge member 20 from the central part. As shown in Step 2 in FIG. 1, in the radial direction of the cylinder, the top part of the bridge member 20 that is close to the upper surface 20a expands toward the cylinder wall 16 and the outer wall 18. In some example configurations as illustrated in Step 2 in FIG. 1, the side surfaces of the bride member 20 are not expanded at a bottom part of the bridge member. The side surface of the expanded top part of the bridge member 20 that is close to the upper surface 20a then comes into contact with the cylinder wall 16 and the outer wall 18, thereby partially filling the gap between the side surface of the bridge member 20 and the cylinder wall 16 and the gap between the side surface of the bridge member 20 and the outer wall 18. In Step 2, as in Step 1, the material of the cylinder wall 16 or the outer wall 18 and the material of the bridge member 20 are not mixed with each other.

In the manufacturing method according to one or more embodiments, the time required for the side surface of the bridge member 20 to come into contact with both the cylinder wall 16 and the outer wall 18 is set in advance as the predetermined time described above. The speed of expansion of the top part of the bridge member 20 varies depending on the composition and shape of the bridge member 20, the speed or rotation of the FSW tool 30 or the shape of the probe 32, for example, the predetermined time described above is set by considering these points. The predetermined time described above, in some example configurations, is the time required for only part of the side surface of the bridge member 20 to come into contact with both the cylinder wall 16 and the outer wall 18, or the time required for most part of the side surface to come into contact with both the cylinder wall 16 and the outer wall 18. The longer the time for which the probe 32 is pressed against the upper surface 20a, the more likely to protrude upward beyond the top deck 10a the top part of the bridge member 20 is. Thus, the predetermined time described above is set, in some example configurations, at an optimal time by considering this point. In some example configurations, in Step 1 and Step 2, the FSW tool 30 (probe 32) is rotating but otherwise is not moved relative to the bridge member 20. In other words, the axis about which the FSW tool 30 (probe 32) is rotating remains stationary, or does not move, with respect to the bridge member 20 in Step 1 and Step 2.

In the manufacturing method according to one or more embodiments, after Step 2, the FSW tool 30 (probe 32) is moved on the upper surface 20a from the central part thereof to the outer wall 18 with the probe 32 being kept pressed against the upper surface 20a, thereby friction-stir welding the outer wall 18 and the bridge member 20 to each other, and after that, the probe 32 is removed from the top deck 10a (Step 3).

Since the probe 32 is rotating, when the FSW tool 30 is moved on the upper surface 20a from the central part thereof to the outer wall 18 with the probe 32 being kept pressed against the upper surface 20a in Step 3, the area of the upper surface 20a that is softened by the frictional heat expands. In addition, the top part of the bridge member 20 filling the gaps between the bridge member 20 and the outer wall 18 in Step 2 is also softened. Furthermore, the outer wall 18 is also softened, beginning with the surface facing the side surface of the bridge member 20. The materials of the softened parts of the outer wall 18 and the bridge member 20 are stirred by the rotation of the probe 32 and mixed with and welded to each other in a welded portion. After that, the probe 32 is removed off the top deck 10a by lifting the probe 32 from the welded part.

The cylinder block manufactured by aluminum die casting potentially contains gas trapped during die casting, and the gas potentially expands to form a blowhole in the cylinder block when the cylinder block becomes molten. Thus, making the outer wall 18 molten during the welding in Step 3 is not desirable in some situations from the viewpoint of the reliability of the bonding. In this regard, the FSW tool 30 does not make the outer wall 18 molten in some example configurations, and can firmly bond the bridge member 20 and the outer wall 18 to each other by softening (without melting) the outer wall 18 by frictional heat to mix the material of the outer wall 18 and the material of the bridge member 20.

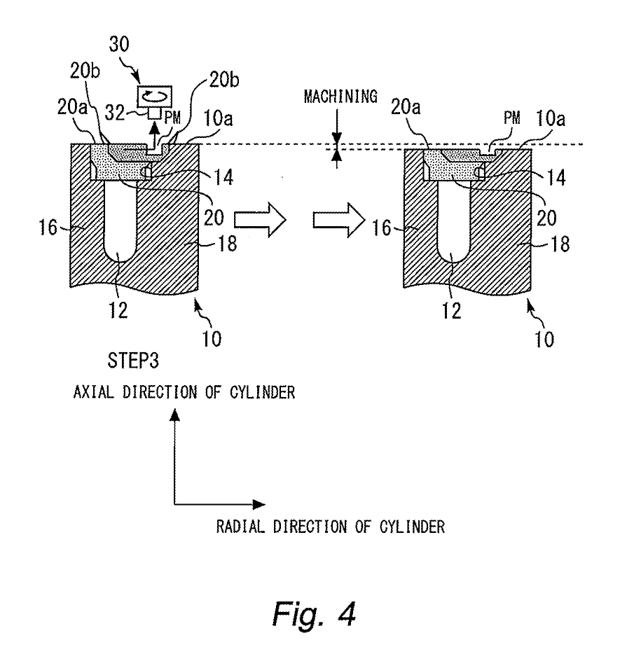

The FSW tool 30 potentially forms burrs during use. As shown in FIG. 4, after Step 3, a burr 20b is potentially formed on the surface the probe 32 has passed through. However, as shown in the right part of this drawing, the top deck 10a is subjected, in some example configurations, to a machining (cutting) to tailor the top deck 10a to the cylinder head, and the burr 20b is removed in the machining. That is, an additional step of removing the burr 20b (other than the machining) is not required. In the machining, the upper surface 20a of the bridge member is shaved, and a bridge that connects the cylinder wall 16 and the outer wall 18 to each other that is flush with the top deck 10a and partially blocks the opening 14 is formed.

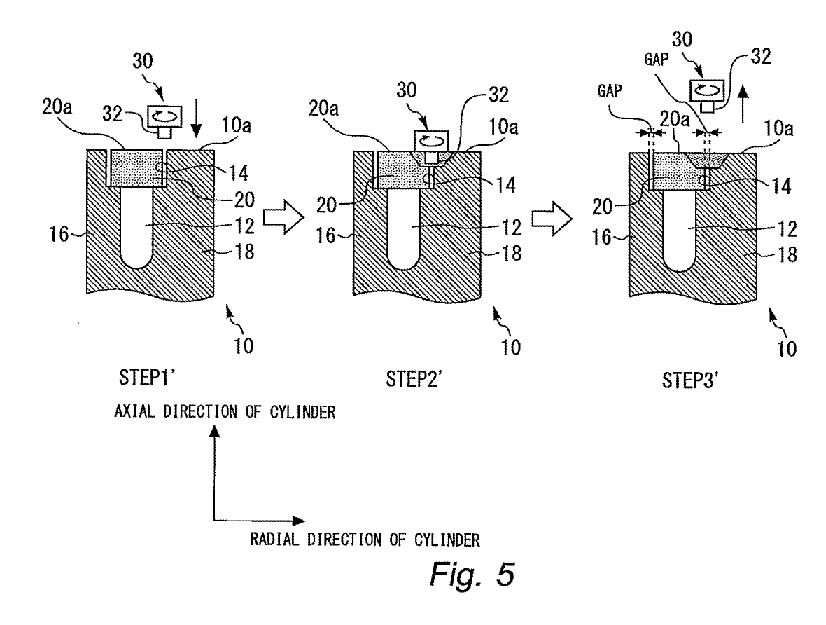

With reference to FIG. 5, advantages of the manufacturing method according to one or more embodiments will be described. FIG. 5 shows a flow of a method for manufacturing a cylinder block according to a comparative example. The steps (Steps 1′ to 3′) of the manufacturing method shown in FIG. 5 differ from the steps (Steps 1 to 3) of the manufacturing method shown in FIG. 1 as described below. First, Step 1′ in FIG. 5 differs from Step 1 in FIG. 1 in that the probe 32 is pressed against the bridge member 20 and the outer wall 18 at the gap therebetween. Similarly, Step 2′ in FIG. 5 differs from Step 2 in FIG. 1 in that the probe 32 is kept pressed against the bridge member 20 and the outer wall 18 at the gap therebetween. Step 3′ in FIG. 5 differs from Step 3 in FIG. 1 in that the FSW tool 30 is not horizontally moved.

If the probe 32 is pressed against the bridge member 20 and the outer wall 18 at the gap therebetween, the outer wall 18 and the bridge member 20 can be softened at the same time and mixed to each other. However, as described above with regard to Step 1 in FIG. 1, the width W₂₀ is smaller than the width W₁₄. Thus, if the bridge member 20 is positioned toward the cylinder wall 16 in Step 1′ in FIG. 5, the gap between the bridge member 20 and the outer wall 18 can be widened. In that case, the gap is potentially not completely filled even if the materials of the outer wall 18 and the bridge member 20 are mixed with each other in Step 2′. Furthermore, even if the bridge member 20 is installed with the side surface thereof in contact with the cylinder wall 16, there can be a slight gap between the two, and the same processings as Steps 2′ and 3′ performed on the side of the outer wall 18 need to be performed on the side of the cylinder wall 16 to fill the gap.

In this regard, in the manufacturing method according to one or more embodiments, since the probe 32 is pressed against the central part of the upper surface 20a in Step 1 in FIG. 1, the top part of the bridge member 20 expands toward both the cylinder wall 16 and the outer wall 18. In addition, since the probe 32 is kept pressed against the central part of the upper surface 20a for the predetermined time in Step 2 in FIG. 1, the side surface of the bridge member 20 is brought into contact with both the cylinder wall 16 and the outer wall 18 to partially fill the gap between the side surface of the bridge member 20 and the cylinder wall 16 and the gap between the side surface of the bridge member 20 and the outer wall 18. In addition, since the FSW tool 30 is moved on the upper surface 20a from the central part thereof to the outer wall 18 with the probe 32 kept pressed against the upper surface 20a in Step 3 in FIG. 1, the materials of the outer wall 18 and the bridge member 20 are mixed with each other and the bridge member 20 and the outer wall 18 are firmly welded to each other. In this way, a cylinder block with the cylinder wall 16 and the outer wall 18 firmly welded to each other by the bridge member 20 is provided.

In one or more embodiments, in Step 3, the FSW tool 30 is moved on the upper surface 20a from the central part thereof to the outer wall 18. This is because of the relationship between the thicknesses in the radial direction of the cylinder between the cylinder wall 16 and the outer wall 18 described with reference to FIG. 2 (thickness T₁₈>thickness T₁₆), that is, because the thicker outer wall 18 can be more stably friction-stir welded to the bridge member 20. In some example configurations with a cylinder block having a cylinder wall and an outer wall in a reverse thickness relationship, the bridge member is friction-stir welded to the cylinder wall, rather than to the outer wall. When the manufacturing method according to one or more embodiments is applied to such a cylinder block material, in Step 3 in FIG. 1, the FSW tool 30 is moved to the cylinder wall 16, rather than to the outer wall 18.

If the thickness of the cylinder wall 16 in the radial direction of the cylinder is equal to the thickness of the outer wall 18 in the radial direction of the cylinder, or if the bridge member 20 can be friction-stir welded to any of the two walls with sufficient stability regardless of the thicknesses of the walls, in Step 3 in FIG. 1, the FSW tool 30 is moved to either the cylinder wall 16 or to the outer wall 18. The modification described here is applicable to the manufacturing method according to one or more embodiments of the present application described below.

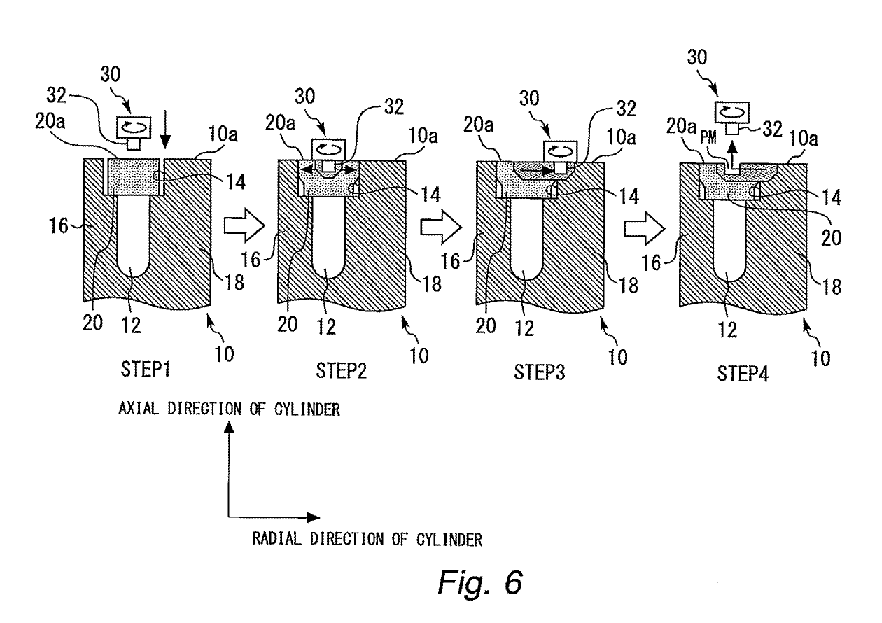

Next, with reference to FIG. 6, a method for manufacturing a semi-closed deck cylinder block of an engine according to one or more embodiments of the present application will be described. FIG. 6 is a diagram for illustrating a flow of the manufacturing method according to one or more embodiments of the present application. As shown in FIG. 6, in the manufacturing method according to one or more embodiments, Steps 1 and 2 are performed. These steps are the same as Steps 1 and 2 in FIG. 1.

In the manufacturing method according to one or more embodiments, after Step 2, the FSW tool 30 is moved on the upper surface 20a in the radial direction of the cylinder from the central part thereof to the outer wall 18 with the probe 32 being kept pressed against the upper surface 20a, thereby friction-stir welding the outer wall 18 and the bridge member 20 to each other (Step 3). After Step 3, the FSW tool 30 is moved from the outer wall 18 back toward the central part of the upper surface 20a to a removal position from which the probe 32 is then removed off the top deck 10a (Step 4).

In one or more embodiments, in Step 3 in FIG. 1, after the outer wall 18 and the bridge member 20 are friction-stir welded to each other, the probe 32 is removed off the top deck 10a by lifting the probe 32 from the welded part. If the probe mark PM (which, as shown in Step 3 in FIG. 1, is concaved part in the welded portion at the top deck) formed as a result of the probe 32 being lifted from the welded part is located above the gap between the side surface of the bridge member 20 and the outer wall 18, the thickness of a portion of the welded part below the probe mark PM is potentially insufficient in some situations, and the reliability of the bonding between the outer wall 18 and the bridge member 20 is potentially insufficient in such situations.

In this regard, in the manufacturing method according to one or more embodiments, after the outer wall 18 and the bridge member 20 are friction-stir welded to each other in Step 3, the FSW tool 30 is moved from the outer wall 18 back to the central part of the upper surface 20a in Step 4 before the probe 32 is removed off the top deck 10a. Thus, the probe mark PM formed as a result of lifting the probe 32 is located at the central part of the upper surface 20a. Thus, the manufacturing method according to one or more embodiments provides a cylinder block with the outer wall 18 and the bridge member 20 welded to each other with higher reliability than the manufacturing method according to one or more embodiments described above does.

In one or more embodiments, the FSW tool 30 is moved from the outer wall 18 back to the central part of the upper surface 20a in Step 4. However, the FSW tool 30 does not always have to be moved back to the central part of the upper surface 20a. The FSW tool 30, in some example configurations, is moved back to a removal position between the outer wall 18 and the central part. The reliability of the bonding between the outer wall 18 and the bridge member 20 can be increased as far as the probe mark PM on the bridge member 20 is located on the inner side than the gap between the side surface of the bridge member 20 and the outer wall 18 (i.e., inward from the gap in the radial direction of the cylinder). Thus, in Step 4, the FSW tool 30, in some example configurations, is moved back to a removal position between the central part of the upper surface 20a and an initial position (as illustrated in Step 1) of the side surface of the bridge member 20 that is closer to the outer wall 18 before the side surface is expanded in Step 2.

Furthermore, the FSW tool 30, in some example configurations, is moved back to a removal position between to the cylinder wall 16 and the central part of the upper surface 20a. However, if the FSW tool 30 is moved back too far, and the probe mark PM is located above the gap between the side surface of the bridge member 20 and the cylinder wall 16, the thickness of the portion of the bridge member 20 filling the gap is reduced in accordance with the probe mark PM, and the reliability of the bonding between the cylinder wall 16 and the bridge member 20 decreases accordingly. Thus, when the FSW tool 30 is moved back to a removal position between the cylinder wall 16 and the central part of the upper surface 20a, the removal position to which the FSW tool 30 is moved back is, in some example configurations, located between the central part of the upper surface 20a and an initial position (as illustrated in Step 1) of the side surface of the bridge member 20 that is closer to the cylinder wall 16 before the side surface is expanded in Step 2. In short, the removal position to which the FSW tool 30 is moved back and from which the probe 32 is removed off the top deck 10a or the upper surface 20a in Step 4, in some example configurations, is located in the radial direction of the cylinder between the initial positions (as illustrated in Step 1) of the side surfaces of the bridge member 20 before the side surfaces are expanded in Step 2.

What is claimed is:

1. A method of manufacturing a semi-closed deck cylinder block, the semi-closed deck cylinder block including a cylinder wall of a cylinder into which a piston is to be inserted, an outer wall that surrounds the cylinder wall with a water jacket interposed therebetween, and a bridge that connects the cylinder wall and the outer wall to each other and blocks a part of an opening of the water jacket at a top deck of the cylinder block, the method comprising the step of:
pressing a probe of a friction stir welding tool against a central part of an upper surface of a bridge member installed in the opening of the water jacket at the top deck, the probe rotating about an axis parallel to a cylinder axis of the cylinder;
keeping the probe pressed against the central part for a predetermined time to cause side surfaces of the bridge member to expand as a result of the probe being pressed against the upper surface thereof and to come into contact with both the cylinder wall and the outer wall;
after the predetermined time, moving the probe to the cylinder wall or the outer wall while keeping the probe pressed against the upper surface to friction-stir weld the bridge member with the cylinder wall or the outer wall to which the probe has moved; and
removing the probe from the top deck after the welding step.

2. The method according to claim 1, wherein
when a thickness of the outer wall in a radial direction of the cylinder is greater than a thickness of the cylinder wall in the radial direction of the cylinder at a position where the bridge member is installed, and
the probe is moved to the outer wall that has the greater thickness in the radial direction of the cylinder in the welding step.

3. The method according to claim 1, wherein
a thickness of the cylinder wall in a radial direction of the cylinder is greater than a thickness of the outer wall in the radial direction of the cylinder at a position where the bridge member is installed, and
the probe is moved to the cylinder wall that has the greater thickness in the radial direction of the cylinder in the welding step.

4. The method according to claim 1, further comprising, between the welding step and the removing step, repositioning the probe back toward the central part of the upper surface of the bridge member while keeping the probe pressed against the upper surface.

5. The method according to claim 4, wherein the repositioning step comprises moving the probe to a removal position between initial positions of the side surfaces of the bridge member before the side surfaces are expanded as a result of the probe being pressed against the upper surface of the bridge member in the keeping step.

6. The method according to claim 5, wherein the removing step comprises removing the probe off the upper surface of the bride member from said removal position.

7. The method according to claim 1, wherein the welding step comprises
softening, without melting, a material of the cylinder wall or the outer wall, and
mixing the softened material of the cylinder wall or the outer wall with a softened material of the bridge member.

8. The method according to claim 1, wherein the keeping step causes the side surfaces of the bride member to expand in a radial direction of the cylinder at a top part of the bridge member, without causing the side surfaces of the bride member to expand at a bottom part of the bridge member.

9. The method according to claim 1, wherein, upon completion of the removing step,
a material of the bridge member and a material of one of the cylinder wall and the outer wall are mixed with each other at one of the side surfaces of the bridge member, and
the material of the bridge member and the material of the other of the cylinder wall and the outer wall contact but are not mixed with each other at the other of the side surfaces of the bridge member.

10. The method according to claim 1, further comprising, upon completion of the removing step, machining the upper surface of the bridge member to form the bridge that connects the cylinder wall and the outer wall to each other, is flush with the top deck, and partially blocks the opening of the water jacket,
wherein the machining step removes burrs formed by the welding step.

11. A cylinder block, comprising:
a cylinder wall of a cylinder into which a piston is to be inserted,
an outer wall that surrounds the cylinder wall;
a water jacket interposed between the cylinder wall and the outer wall; and
a bridge that connects the cylinder wall and the outer wall to each other, and blocks a part of an opening of the water jacket at a top deck of the cylinder block, wherein
side surfaces of the bridge at a top part of the bridge extend in a radial direction of the cylinder outwardly beyond the side surfaces at a bottom part of the bridge, and
one of the side surfaces of the bridge at the top part of the bridge is connected to one of the cylinder wall and the outer wall at a welded portion.

12. The cylinder block according to claim 11, wherein
a thickness of the outer wall in the radial direction of the cylinder is greater than a thickness of the cylinder wall in the radial direction of the cylinder at a position where the bridge is located, and
said one of the side surfaces of the bridge at the top part of the bridge is connected to the outer wall at said welded portion.

13. The cylinder block according to claim 11, wherein
a thickness of the cylinder wall in the radial direction of the cylinder is greater than a thickness of the outer wall in the radial direction of the cylinder at a position where the bridge is located, and
said one of the side surfaces of the bridge at the top part of the bridge is connected to the cylinder wall at said welded portion.

14. The cylinder block according to claim 11, wherein
the side surfaces of the bridge at the bottom part of the bridge are spaced from the cylinder wall and the outer wall by respective gaps.

15. The cylinder block according to claim 14, wherein
the welded portion has a probe mark which is concaved part at the top deck, and
the probe mark is located, in the radial direction of the cylinder, at a position other than directly above the gaps between (i) the side surfaces of the bridge at the bottom part of the bridge and (ii) the cylinder wall and the outer wall.

16. The cylinder block according to claim 15, wherein
the probe mark is located, in the radial direction of the cylinder, between the side surfaces of the bridge at the bottom part of the bridge.

17. The cylinder block according to claim 15, wherein
the probe mark is located, in the radial direction of the cylinder, closer to the welded portion than to the other of the side surfaces of the bridge at the top part of the bridge.

18. The cylinder block according to claim 15, wherein
the probe mark is located, in the radial direction of the cylinder, farther from the welded portion than from the other of the side surfaces of the bridge at the top part of the bridge.

19. The cylinder block according to claim 11, wherein
a material of the bridge and a material of one of the cylinder wall and the outer wall are mixed with each other in the welded portion at said one of the side surfaces of the bridge at the top part of the bridge, and
the material of the bridge and the material of the other of the cylinder wall and the outer wall contact but are not mixed with each other at the other of the side surfaces of the bridge at the top part of the bridge.

20. The cylinder block according to claim 11, wherein
the bridge is flush with the top deck.
